(19) United States
(12) Patent Application Publication
(10) Pub. No.: US 2007/0249357 A1
(43) Pub. Date: Oct. 25, 2007

(54) Method for Switching Between Two Telephone Services

(75) Inventors: Sophie Aveline, Paris (FR); Nathalie Beziot, Le Plessis Robinson (FR)

Correspondence Address: COHEN, PONTANI, LIEBERMAN & PAVANE, 551 FIFTH AVENUE, SUITE 1210, NEW YORK, NY, 10176, US

(73) Assignee: France Telecom, Paris (FR)

(21) Appl. No.: 11/628,348

(22) PCT Filed: May 24, 2005
(86) PCT No.: PCT/FR05/01277

§ 371 Date: Jan. 25, 2007

(30) Foreign Application Priority Data
Jun. 1, 2004 (FR) 0451079

(51) Int. Cl. H04Q 7/20

(52) U.S. Cl. 455/445; 455/422.1

(57) ABSTRACT

When two terminals (T1, T2) communicate with each other via a first service via a network, switching from the first telephone service to a second telephone service enables the two terminals (T1, T2) to continue to communicate with each other via the second telephone service. In order to carry out said switching, a telephone service transformer (6) interrupts the communication between the two terminals (T1, T2) using the first telephone service; calls the two terminals (T1, T2) in parallel via the second telephone service; and then interconnects the two terminals (T1, T2) by joining the respective communications established between the transformer (6) and the two terminals (T1, T2) in order to establish a communication between the two terminals (T1, T2) via the second telephone service.

The invention relates to a method of switching between two telephone services, for example a video telephone service and a voice telephone service.

In cellular telephone systems, for example UMTS third generation networks, the radio coverage area of the UMTS access network is divided into a plurality of cells each having its own “Node B” provided with a transceiver and adapted to communicate with the mobile terminals situated in its cell. If a mobile terminal moves during a call, the network detects attenuation of the transmission signal between the terminal and the “Node B” to which it is connected and finds another available “Node B” in order for the terminal to change cell. Thus the terminal changes the “Node B” to which it is connected whilst continuing the call in progress, without interrupting it. This intercellular transfer mechanism is commonly referred to as “handover”. To provide handover throughout the territory covered, a mobile at any point in the territory must receive signals from at least two “Nodes B” in order to be able to change cell (to a cell in which the received signal is of better quality).

Third generation cellular telephone systems, in particular the UMTS (Universal Mobile Telecommunication System), seek to increase bit rates in order in particular to speed up multimedia calls, for example video calls, between mobile terminals. Third generation cellular telephone operators are therefore envisaging offering their users video telephone services.

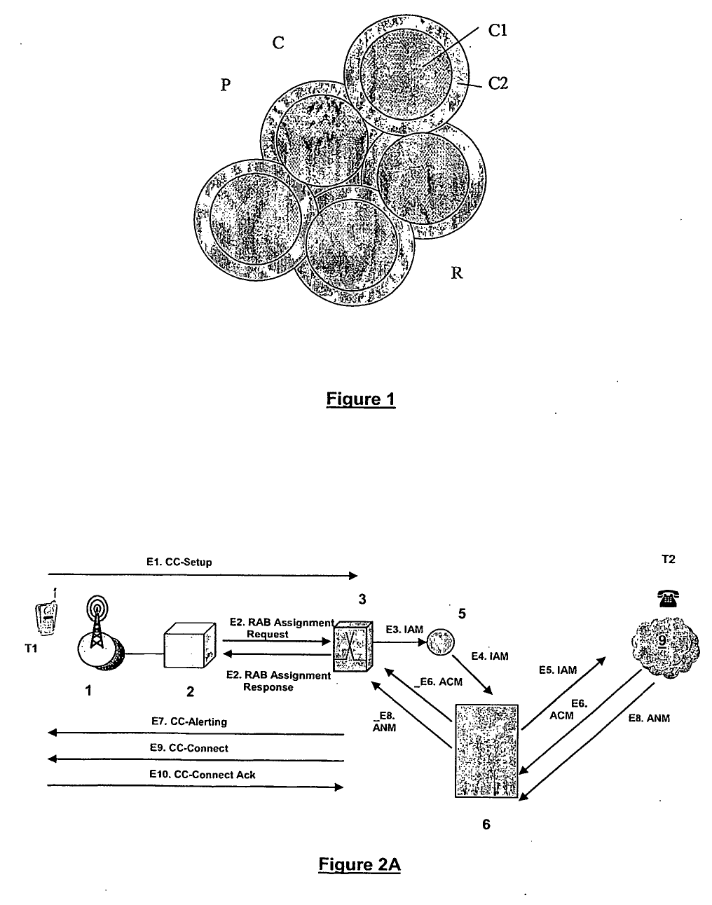

However, to provide video call handover, the radio coverage of the UMTS access network must be made more dense than is required for providing handover for voice only calls, for two reasons specific to the UMTS. Firstly, in a UMTS cell C (FIG. 1), the video telephone service and the voice telephone service are both operational in the central portion C1 of the cell C but only the voice telephone service is operational in the peripheral portion C2 of the cell. As can be seen in FIG. 1, in territories currently covered by a UMTS, adjacent cells overlap partly, but only at the periphery. Because of this, the voice telephone service is provided over the whole of the territory covered, but not the video telephone service. Secondly, UMTS cells are said to “breathe”: the greater the number of mobile users in a given cell, the smaller the area of that cell becomes. For the two reasons stated just above, it is difficult to guarantee video telephone service continuity when a mobile user moves from one cell to another. Under such circumstances, there is a risk that the user's video call may be interrupted.

This problem of video telephone service radio coverage is addressed in the standardization context by the 3GPP (Third Generation Partnership Project), which is the UMTS standardization organization, in particular in document SP-030724. To solve this problem, it is envisaged to develop a switching service aiming to switch automatically from the video telephone service to the voice telephone service if the video call between two terminals, one of which is a mobile terminal, becomes degraded, so that the call continues via the voice telephone service and interruption thereof is therefore avoided. Two solutions have been envisaged for implementing this switching service.

The first solution relies on the “multicall” service defined in UMTS Release 99. This function enables a user to set up and maintain simultaneously two parallel telephone calls across circuit switching sections of the third generation cellular telephone network. A mobile terminal with access to the “multicall” service can therefore set up simultaneously a video call and a parallel voice call. It is envisaged to use the “multicall” service to implement the switching service referred to above. If the video telephone call between two mobile terminals becomes degraded, because one of the terminals, which is mobile, enters an area that is not covered by the video telephone service, that terminal can issue a call via the voice telephone service to the terminal with which it was previously communicating in video mode. After the voice call has been set up, the video call may be abandoned.

That solution has various drawbacks. The first drawback results from the fact that establishing the voice call requires a certain amount of set-up time, perceptible by the user, during which the parallel video call is degraded. During the voice call set-up time, there is therefore a risk of the quality of the call being unsatisfactory from the user's point of view. The second drawback is linked to the fact that that solution can be implemented only between terminals supporting and having access to the “multicall” service. Unfortunately, this service is not defined for terminals of the fixed telephone network. Moreover, although it is defined for terminals of the cellular telephone network, it is at present not yet supported by mobile terminals available to users and is equally lacking in the forecasts of mobile terminal manufacturers. A third drawback resides in the fact that using the “multicall” service requires adaptation of the MSCs (mobile service switching centers) of the core network of the UMTS, for which manufacturers have yet to make provision.

The second solution relies on the “service change” concept defined in UMTS Release 5, which enables switching from video mode to voice mode, and vice versa, during a telephone call between two terminals, and providing the characteristics of both modes are specified at the time of setting up the call and are supported by both terminals.

It is also envisaged to use the “service change” facility to implement the above-mentioned switching service, in the following manner: if the video mode telephone call between two terminals is becoming degraded, one of the terminals can request that the call be switched to the voice mode.

That solution has certain drawbacks, however. Firstly, implementing the “service change” facility requires all of the elements of the UMTS communications system to be modified: mobile terminals, RNCs (access network controllers), and MSCs (mobile service switching centers). Equipment manufacturers have yet to envisage such modifications. Secondly, a terminal having access to a “service change” facility offered by its own operator might not benefit from that facility when roaming, if the roaming partner operator has not adapted its network to suit the facility, or when communicating with a terminal of another mobile telephone operator, if that interconnection partner operator has not adapted its network to suit the facility.

Although the “multicall” service and the “service change” facility are defined in UMTS Release 99 and UMTS Release 5, respectively, neither mobile terminals nor the current mobile network infrastructure are adapted to implement them. It is therefore not possible to render operational in the short term the two solutions explained above for providing a service for switching from video telephone service to voice telephone service in order to avoid total interruption of the call between the two terminals involved in the video call because of the video call being degraded.

The problem addressed by the invention therefore consists in proposing an alternative to the above two solutions that can be implemented with only limited modification of the communications system.

It should be understood that although the invention stems from the problem of switching specifically between the video telephone service and the voice telephone service, the invention is not limited to this particular situation, and applies more generally to the problem of switching between two telephone services.

To this end, the invention consists in a method of switching from a first telephone service to a second telephone service in which, for two terminals communicating with each other via the first service and via a network, switching from the first telephone service to the second enables the two terminals to continue to communicate with each other via the second telephone service, the method being characterized in that, to switch from the first telephone service to the second, a telephone service transformer:

interrupts the call between the two terminals using the first telephone service;

calls the two terminals in parallel via the second telephone service; and then

interconnects the two terminals by joining the two calls set up between the transformer and the respective terminals in order to set up a call between the two terminals via the second telephone service.

The invention therefore entails the first telephone service intentionally cutting off the call between the two terminals, initiating two calls between a transformer and the respective terminals via the second telephone service, and then joining the two calls to interconnect the two terminals in order for them to communicate with each other via the second telephone service. It is found that implementing this method requires only a few modifications to the communications system. In fact, it suffices to add to the communications system a transformer in a call break situation between the two terminals.

In a preferred embodiment, the first telephone service is a video telephone service and the second service is a voice telephone service.

Under such circumstances, the method of the invention switches from a video call between two terminals to a voice call, for example if one of the terminals is mobile and enters an area that is not covered by the video telephone service.

Advantageously, at the time of setting up the call using the first telephone service between the two terminals, with a “calling” one of the two terminals issuing a call to the “called” other terminal:

i) the network routes this call to the transformer to set up a call via the first telephone service between the calling terminal and the transformer; and

ii) on receiving the call from the calling terminal, the transformer calls the called terminal in order to set up a call with it via the second telephone service, and then interconnects the two terminals by joining the respective calls between the calling terminal and the transformer and between the transformer and the called terminal in order to set up a call between the two terminals via the first telephone service.

Accordingly, at the time of setting up the call between the two terminals using the first telephone service, the network has the call transiting through the transformer.

The invention also consists in a telephone service transformer for a network, the transformer comprising:

i) call break means adapted to interrupt a call between two terminals using the first telephone service;

ii) calling means adapted to call the two terminals in parallel in order to set up respective calls to them via the second telephone service; and

iii) joining means adapted to interconnect the two terminals by joining the two calls between the transformer and the respective terminals in order to set up a call between the terminals via the second telephone service.

The invention finally consists in a call routing device characterized in that, for a predefined telephone service, it comprises means for identifying the telephone service used for a call between two terminals at the time of setting up the call and routing means for directing the call issued by a “calling” one of the terminals to the “called” other terminal to a telephone service transformer as defined above.

The invention can be better understood in the light of the following description with reference to the appended drawings of one particular implementation of the method of switching between two telephone services, and of one particular embodiment of the telephone service transformer and of the call routing device, in which drawings:

FIG. 1 is a diagrammatic view of UMTS cells providing a voice telephone service over the whole of their coverage area and a video telephone service over a portion only of their coverage area;

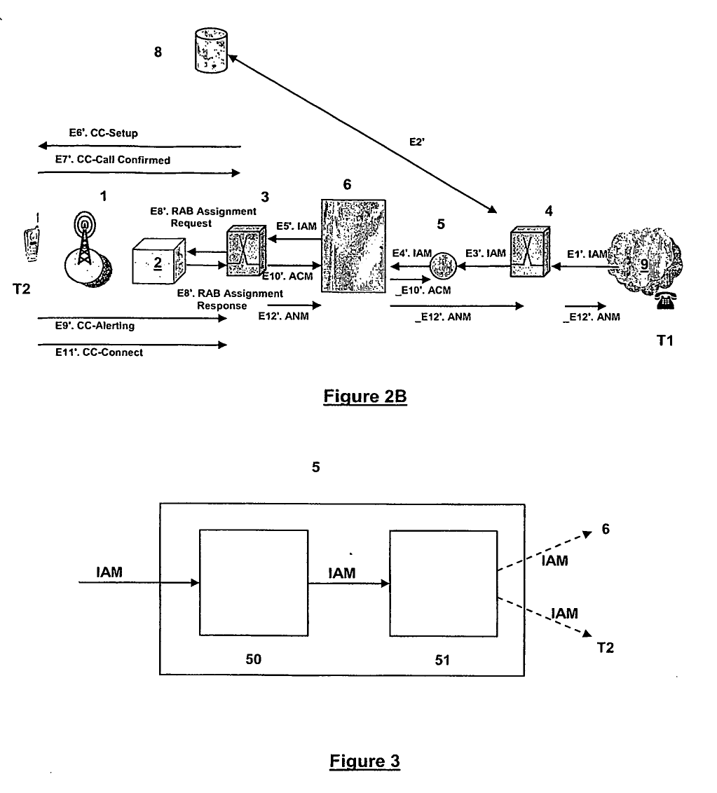

FIG. 2A shows a first embodiment of the elements of a communications system of a FIG. 1 cellular telephone system for an outgoing call;

FIG. 2B shows a first embodiment of the elements of a communications system of a FIG. 1 cellular telephone system for an incoming call;

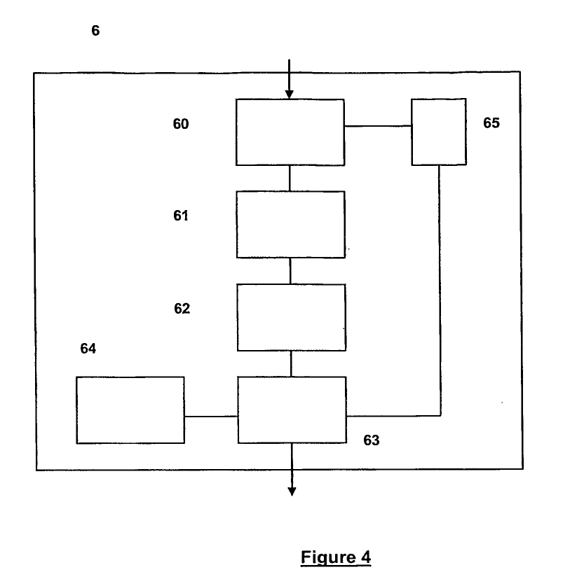

FIG. 3 is a functional block diagram of a call router shown in FIGS. 2A and 2B; and

FIG. 4 is a functional block diagram of a telephone service transformer shown in FIGS. 2A and 2B.

FIGS. 2A and 2B show a third generation mobile telephone system, here a UMTS (Universal Mobile Telecommunication System) network, incorporating a video telephone or “videophone” service enabling users to communicate with each other by video (i.e. by voice and moving pictures) and a voice telephone system enabling users to communicate with each other by voice alone. In the manner known in the art, this system comprises a plurality of “Nodes B” 1, RNCs (access network controllers) 2, MSCs (mobile service switching centers) 3, and G-MSCs 4 serving as gateways between the UMTS network and the external switched telephone network, which includes the ISDN (integrated service digital network) 9.

Each Node B 1 is provided with a transceiver providing the radio coverage of a cell, which comprises a central portion C1 and a peripheral portion C2 (FIG. 1). The video telephone service and the voice telephone service are operational in the central portion C1 of the cell, but only the voice telephone service is operational in the peripheral portion C2 of the cell. As can be seen in FIG. 1, adjacent cells overlap partially at the periphery with the result that the voice telephone service is operational over the whole of the region R covered by the cells inside the perimeter P represented in dotted line in FIG. 1, although the video telephone service is not operational over the whole of this region R because certain peripheral areas C2 of the cell C are not covered by central areas C1 of adjacent cells.

The system further comprises call routers 5 and telephone service transformers 6. In the particular example of the present description, each transformer 6 is connected to a plurality of call routers 5 and, conversely, each router 5 is connected to a plurality of transformers 6. Alternatively, each transformer could be connected to a single router. The number of call routers 5 and the number of transformers 6 depend on the amount of video telephone traffic and on the call processing capacities on the router 5 and the transformer 6.

First note that:

the term “outgoing call” denotes a call made at the initiative of a mobile terminal (to another mobile terminal or to a fixed terminal), and

the term “incoming call” denotes a call to a mobile terminal (made at the initiative of another mobile terminal or of a fixed terminal).

For an outgoing call, the UMTS communications system comprises, in this order (see FIG. 2A): the calling mobile terminal T1, a “Node B” 1, an RNC 2, an MSC 3, a call router 5, and a transformer 6. For an incoming call, the UMTS communications system comprises, in this order (see FIG. 2B): a G-MSC 4, a call router 5, a transformer 6, an MSC 3, an RNC 2, a “Node B” 1, and the called mobile terminal T2.

A call router 5 is a device adapted to route to the transformer 6 calls using the video telephone service from a “calling” terminal to a “called” terminal. Referring to FIG. 3, it comprises:

a module 50 for identifying the nature of the call, adapted to determine the telephone service used for the identified call; and

a routing module 51 adapted to direct the call either to the transformer 6 or directly to the called terminal, according to whether it is a call via the video telephone service or a call via another telephone service, for example the voice telephone service.

The identification module 50 is adapted to identify the type of service used by each call from a calling terminal to a called terminal if at least one of the two terminals is a mobile terminal of the UMTS network. For outgoing calls, the identification module 50 analyses the content of ‘Other Rate Adaptation’ and ‘FNUR’ fields in a bearer capability description portion (“ISDN Bearer Capability”) of the IAM (Initial Address Message) sent by the MSC 3 to the called terminal on receiving a call set-up message CC-Setup from the calling mobile terminal initiating the call. For an incoming call at the initiative of the fixed terminal of the ISDN 9, the identification module 50 analyses the content of the ‘Other Rate Adaptation’ and ‘FNUR’ fields in the bearer capability description portion (“ISDN Bearer Capability”) of the IAM (Initial Address Message) sent by the ISDN 9 to the G-MSC 5. The module 50 identifies that the call is a video telephone call:

‘Other Rate Adaptation’=“H223&H245”

‘FNUR’=64 kilobits per second (kbps).

The routing module 51 is adapted to route the call identified by the module 50 to the transformer 6 if it is a video telephone call or directly to the called terminal otherwise.

The transformer 6 is adapted to change the telephone service used between two terminals during a call. In the mobile telephone system represented in FIGS. 2A and 2B, it is situated between the MSC 3 of the UMTS network and the gateways between the UMTS network and networks external to the UMTS network, in particular G-MSC 4 networks. Referring to FIG. 4, the transformer 6 comprises:

a module 60 for receiving a call set-up message containing the calling number and the called number;

a module 61 for detecting degraded call quality between two terminals;

a call break module 62 adapted to interrupt a video call in progress between two terminals;

a call module 63 adapted to call terminals;

a joining module 64 adapted to interconnect two terminals by joining two calls between the transformer 6 and the respective terminals; and

a memory 65 for storing calling and called numbers.

The reception module 60 is adapted:

to receive a call set-up message containing the calling number and the called number, here an IAM (Initial Address Message), coming via a call router 5 either from an MSC 3 for an outgoing video call (FIG. 2A) or from a G-MSC 4 for an incoming video call (FIG. 2B); and

to extract the calling and called numbers from the IAM and store them in the memory 65 in association with each other.

The detection module 61 is adapted to detect degraded video call quality between two terminals, here by analyzing H.263 protocol video coding frames that transport coded video data packets between the two terminals. As a function of a call quality indicator, for example the number of missing or erroneous data packets, the detection module 61 determines when the quality of the video call between two terminals becomes insufficient for the call to be able to continue properly. For example, video call quality may become unsatisfactory because one of the two terminals is mobile and enters an area situated at the periphery of a “Node B” cell in which the video telephone service is not operational.

The call break module 62 is adapted to interrupt a video call in progress between two terminals at the command of the detection module 61 if the video call quality becomes insufficient and to signal to the two terminals that a call using the voice telephone service is about to be set up. Each terminal is thus advised of the temporary nature of the call interruption and can signal to its user that a voice call is about to be set up, as explained in the description of the method.

The call module 63 is adapted to issue calls both at the time a video call is set up between “calling” and “called” terminals and also after the call break module 62 has interrupted a video call in progress between two terminals:

At the time of setting up a video call to a “called” terminal at the initiative of a “calling” terminal, the router 5 routes the call to the transformer 6. The call module 62 is adapted, on receiving this video call, to call the called terminal via the video telephone service, inserting the identity of the calling terminal, here its call number, into a caller identification field sent to the called terminal.

After interruption of a video call between two terminals, the call module 63 is adapted to call the two terminals in parallel to set up respective calls to them via the voice telephone service.

The joining module 64 is adapted, after interruption of a video call between two terminals and setting up of two voice calls between the transformer 6 and the respective terminals, to join the call between the transformer 6 and one of the terminals to the call between the transformer 6 and the other terminal, i.e. to interconnect these two calls end-to-end in order to establish communication between the two terminals via the voice telephone service.

The method of switching from the video telephone service to the voice telephone service, corresponding to the operation of the call routers 5 and the transformer 6, is described below.

Outgoing Video Call (FIG. 2A)

An outgoing video call to a “called” terminal T2, for example a terminal of the fixed ISDN 9, made at the initiative of a “calling” UMTS mobile terminal Ti is initiated by a CC-Setup message (E1), as defined in Technical Specification TS24.008 of the 3GPP telecommunications standard, sent from the calling terminal T1 to the MSC 3 to which the calling terminal T1 is connected via the UTRAN consisting of the Node B 1 and the RNC 2 to which the terminal T1 is connected. After the MSC 3 receives the CC-Setup message, the UMTS network allocates the necessary resources in the UTRAN by means of an RAB Assignment procedure (E2). Once the resources have been allocated, the MSC 3 sends an IAM (E3) to the terminal T2. This message comprises a caller identification field containing the number of the calling terminal T1, a called party identification field containing the number of the called terminal T2, and a bearer capability description portion “ISDN Bearer Capability” containing the following fields:

‘Other Rate Adaptation’=“H223&H245”

‘FNUR’=64 kbps.

The call router 5 intercepts the IAM and identifies a video call (i.e. a call using the video telephone service) by analyzing the content of the ‘Other Route Adaptation’ and ‘FNUR’ fields and then routes the call to the transformer 6 to which it is connected, forwarding to it the received IAM (E4).

The transformer 6 receives the IAM, extracts the calling and called numbers from it, and stores them in memory in association with each other. The transformer 6 then calls the called terminal T2 and finalizes the setting up of the call from the calling terminal T1, in the following manner:

To call the terminal T2, the transformer 6 sends a new IAM (E5) to the terminal T2, inserting therein the identity of the calling terminal T1, consisting here of the call number of the terminal T1 in the caller identification field. The call is therefore routed from the calling terminal Ti to the called terminal T2 via the transformer 6 by means of two IAM coming from the MSC 3 (E3) and the transformer 6 (E5), respectively, and both containing the number of the calling terminal T1 in the caller identification field. Accordingly, from the point of view of the called terminal T2, the source of the received call is the calling terminal T1 and not the transformer 6. When the called party T2 has been advised by a ringer that the call has been received, an ACM (Address Complete Message) of the ISUP (ISDN User Part) layer (E6) is sent from the called terminal T2 to the transformer 6. When the called party T2 picks up, an ANM (Answer Message) (E8) is sent to the transformer 6 and a video telephone call is therefore set up between the terminal T2 and the transformer 6.

The process of setting up the call between the calling terminal T1 and the transformer 6 terminates as follows: the ACM (E6) indicating that the called terminal T2 has been alerted by a ringer is forwarded to the MSC 3 by the transformer 6 (_E6). This information is sent to the calling terminal T1 by the MSC 3 by means of a CC Alerting message (E7). Similarly, the ANM (E8) indicating that the called terminal T2 has picked up is forwarded to the MSC 3 by the transformer 6 (_E8) and this information is sent to the calling terminal by the MSC 3 by means of a CC Connect message (E9). The calling terminal T1 then sends the MSC 3 a CC Connect Ack message (E10) to confirm that the call has been set up. A video telephone call between the calling terminal T1 and the transformer 6 is therefore set up.

After setting up two video calls between the transformer 6 and the terminals T1 and T2, respectively, the transformer 6 joins the two calls in order to interconnect the two terminals T1 and T2 via the video telephone service. The two terminals T1 and T2 therefore communicate through the video telephone service, via the transformer 6. However, the involvement of the transformer 6 is visible neither to the calling terminal nor to the called terminal. Once interconnected, the terminals T1 and T2 communicate via the video telephone service.

Incoming Video Call (FIG. 2B)

An incoming video call to a mobile terminal T2 of the UMTS network, made for example at the initiative of a fixed terminal T1 of the ISDN 9, is routed by the ISDN 9 to a G-MSC 4 by means of an IAM (E1′) comprising a caller identifier field containing the number of the calling terminal T1, a called party identification field containing the number of the called terminal T2, and a bearer capability description portion “ISDN Bearer Capability” containing the following fields:

‘Other Rate Adaptation’=“H223&H245”

‘FNUR’=64 kbps.

Because the G-MSC 4 has no information as to the location of the called mobile terminal T2, it consults (E2′) the HLR (Home Location Register) 8, which in turn consults the VLR (Visitor Location Register), not shown, which gives the location of the terminal T2, to obtain a MSRN (Mobile Station Roaming Number) that is used to route the IAM from the G-MSC 5 to the destination MSC 3 (E3′). The IAM is intercepted by a call router 5 which identifies the call as a video call by analyzing the content of the ‘Other Rate Adaptation’ and ‘FNUR’ fields. The router 5 then routes the call to the transformer 6 with which it is associated, forwarding to it the received IAM (E4′).

The transformer 6 receives the IAM, extracts the calling and called numbers from it, and stores them in memory in association with each other. The transformer 6 then calls the called terminal T2 and finalizes the setting up of the call with the calling fixed terminal T1, in the following manner:

To call the terminal T2, the transformer 6 sends the MSC3 to which the terminal T2 is connected a new IAM (E5′), inserting therein the identity of the calling terminal T1, consisting here of the call number of T1 in the caller identification field. The call is therefore routed to the called terminal T2 via the transformer 6 by means of two IAM coming from the ISDN 9 (E1′) and the transformer 6 (E5′), respectively, and both containing the number of the calling terminal T1 in the caller identification field. Accordingly, from the point of view of the called terminal T2, the source of the received call is the calling terminal T1 and not the transformer 6. The call set-up process between the transformer 6 and the mobile terminal T2 continues in the manner known in the art: on reception of the IAM, the MSC 3 sends a CC-Setup message (E6′) to the terminal T2 which, on receiving this message, sends back a CC-Call Confirmed message (E7′). The UMTS network then allocates the necessary resources in the UTRAN, consisting of the Node B 1 and the RNC 2 to which the terminal T2 is connected, by means of a RAB Assignment procedure (E8′) When the called terminal T2 rings, a CC-Alerting message (E9′) is sent to the MSC 3 and an ACM (Address Complete Message) (E10′) is relayed to the transformer 6. When the called terminal T2 picks up, a CC-Connect message (E11′) is sent from the terminal T2 to the MSC 3 and an ANM (Answer Message) (E12′) indicating that the called party T2 has picked up is then relayed by the MSC 3 to the transformer 6. A video telephone call is therefore set up between the called terminal T2 and the transformer 6.

The process of setting up the call between the calling terminal T1 and the transformer 6 terminates as follows: the transformer 6 forwards to the calling terminal T1 of the fixed ISDN 9 the ACM (_E10′) coming from the called terminal T2 and indicating that the terminal T2 has been alerted to the call by a ringer and then the ANM (_E12′) coming from the called terminal T2 and indicating that the called terminal T2 has picked up. The video call between the transformer 6 and the called terminal Ti is therefore set up.

After setting up two video calls between the transformer 6 and the terminals T1 and T2, respectively, the transformer 6 joins the two calls in order to interconnect the two terminals T1 and T2 via the video telephone service.

It should be emphasized here that the involvement of the transformer 6 is visible neither to the calling terminal T1 nor to the called terminal T2.

Video Telephone Service to Voice Telephone Service Switching Process

During the video call between the two terminals T1 and T2, at least one of the two terminals belonging to the UMTS network (incoming or outgoing call), the transformer 6 analyses the H.263 protocol video coding frames that transport coded video data packets between the two terminals T1 and T2. In the particular example of the present description, the transformer 6 monitors video call quality by regularly evaluating the number of missing or erroneous data packets.

A video call between two terminals T1 and T2 is degraded if one of the two terminals T1 or T2 is mobile and finds itself in an area situated at the periphery of a UMTS cell in which video telephone service quality is insufficient. The transformer 6 detects the degraded video call quality and then interrupts the call by sending a warning message in parallel to each of the two terminals T1 and T2, in this instance an H.245 negotiation protocol UserInputIndication message, informing the terminals that a voice call is about to be set up. On receipt of this message, each terminal T1, T2 signals this information to its user, here by displaying a message on the terminal. Instead of this, or in addition to this, on receipt of the warning message, each terminal T1, T2 could freeze the last image displayed for the duration of the call interruption or issue a voice warning message.

After interrupting the call between the two terminals T1 and T2, the transformer 6 calls the two terminals T1 and T2 in parallel via the voice telephone service, sets up in this way a first voice call with the terminal T1 and a second voice call with the terminal T2, and then interconnects the two terminals T1 and T2 by joining the two voice calls. Communication between the two terminals T1 and T2 via the voice telephone service is thus established through the transformer 6. After the momentary interruption of the call, the two terminals T1 and T2 continue their call via the voice telephone service.

In a different implementation of the invention, the function of routing video calls to the transformer 6 is integrated into the MSC 3 and the G-MSC 5 of the UMTS network, which therefore serve as call routing devices. Under such circumstances, for an outgoing call, the video call identification module incorporated in the MSC 3 is adapted to analyze the content of the ‘Other Rate Adaptation’ and ‘FNUR’ fields in the bearer capability description portion (“IE Bearer Capability”) of the call set-up message CC-setup coming from the calling terminal and initiating the call. For an incoming call, it is the video call identification module incorporated in the G-MSC 5 that is adapted to analyze the content of the ‘Other Rate Adaptation’ and ‘FNUR’ fields in the bearer capability description portion (“ISDN Bearer Capability”) of the IAM coming from the ISDN 9.

In the above description, the transformer 6 makes it possible to switch from the video telephone service to the voice telephone service. However, the invention could naturally be applied to switching between two telephone services other than those described.

Glossary

This glossary is a list of the English-language abbreviations used in the present patent application. These abbreviations are defined in the 3GPP telecommunications standard.
ACM Address Complete Message
ANM Answer Message
CC Call Control
ETSI European Telecommunications Standards Institute

FNUR Fixed Network User Rate
3GPP Third-Generation Partnership project (of ETSI)
G-MSC Gateway MSC
HLR Home Location Register
IAM Initial Address Message
ISDN Integrated Service Digital Network
ISUP ISDN User Part
MSC Mobile Switching Centre
RAB Radio Access Bearer
RNC Radio Network Controller
UMTS Universal Mobile Telecommunication System

1. A method of switching from a first telephone service to a second telephone service in which, for two terminals (T1, T2) communicating with each other via the first service and via a network, a switching from the first telephone service to the second telephone service is proceeded in order for the two terminals (T1, T2) to continue to communicate with each other via the second telephone service, wherein in order to switch from the first telephone service to the second telephone service, a telephone service transformer (6):
interrupts the communication between the two terminals (T1, T2) using the first telephone service;
calls the two terminals (T1, T2) in parallel via the second telephone service; and then interconnects the two terminals (T1, T2) by joining the two communications established between the transformer (6) and the respective terminals (T1, T2) in order to establish a communication between the two terminals (T1, T2) via the second telephone service.

2. The method according to claim 1, wherein the first telephone service is a video telephone service and the second telephone service is a voice telephone service.

3. The method according to claim 1, wherein, at the time of establishing the communication using the first telephone service between the two terminals (T1, T2), with one of the two terminals (T1), the “calling” terminal issuing a call to the other terminal (T2), the “called” terminal:
i) the network (5) routes this call to the transformer (6) to establish a communication via the first telephone service between the calling terminal (T1) and the transformer (6); and
ii) on receiving the call from the calling terminal (T1), the transformer (6) calls the called terminal (T2) in order establish a communication with it via the first telephone service, and then interconnects the two terminals (T1, T2) by joining the respective communications between the calling terminal (T1) and the transformer (6) and between the transformer (6) and the called terminal (T2) in order to establish a communication between the two terminals (T1, T2) via the first telephone service.

4. The method according to claim 3, wherein, on receiving the call from the calling terminal (T1), the transformer (6) stores the numbers of the calling terminal (T1) and the called terminal (T2) in order to call them subsequently to establish the communication between the two terminals (T1 and T2) via the second telephone service.

5. A method according to claim 3, wherein, when it calls the called terminal (T1) via the second telephone service, the transformer inserts the identity of the calling terminal (T2) into a caller identification field sent to the called terminal (T2).

6. The method according to claim 1, wherein the transformer (6) monitors the quality of the communication using the first telephone service between the two terminals (T1, T2) and interrupts the communication on detecting degraded communication quality.

7. The method according to claim 1, wherein, after interrupting the communication between the two terminals (T1, T2) using the first telephone service, the transformer indicates to each of the two terminals (T1, T2) that a communication via the second telephone service is about to be established.

8. A telephone service transformer for a network, the transformer comprising:
i) call break means (62) adapted to interrupt a communication between two terminals (T1, T2) using the first telephone service;
ii) calling means (63) adapted to call the two terminals (T1, T2) in parallel in order to establish respective to communications with them via the second telephone service; and
iii) joining means (64) adapted to interconnect the two terminals (T1, T2) by joining the two communications between the transformer (6) and the respective terminals (T1, T2) in order to establish a communication between the terminals via the second telephone service.

9. The transformer according to claim 8, wherein, on receiving a call via the first telephone service issued by a “calling” terminal (T1) to a “called” other terminal (T2), said call being routed to the transformer (6) via the network (5), the calling means (63) call the called terminal (T2) via the first telephone service and the joining means (64) interconnect the two terminals (T1, T2) by joining the respective communications between the calling terminal (T1) and the transformer (6) and between the transformer (6) and the called terminal (T2) in order to establish the communication between the two terminals (T1, T2) via the first telephone service.

10. The transformer according to claim 9, including means for inserting the identity of the calling terminal into a caller identification field sent to the called terminal (T2) at the time of setting up the call between the transformer (6) and the called terminal (T2).

11. The transformer according to claim 8, including means (61) for detecting degrading of a communication between two terminals (T1, T2) adapted to command a change of telephone service used for said communication.

12. The transformer according to claim 8, including means (62) for indicating to the two terminals (T1, T2), after interruption of their communication via the first telephone service, that a communication using the second telephone mode is about to be established.

13. A call routing device, comprising means (50) for identifying the telephone service used for a communication between two terminals (T1, T2) at the time of establishing said communication and, for a predefined telephone service, routing means (51) for directing the call issued by one of the terminals (T1), the “calling” terminal, to the other terminal (T2), the “called” terminal, to a telephone service transformer (6) according to claim 8.

14. The call routing device according to claim 13, wherein the call routing device is incorporated in a mobile service switching centre (3).

15. The telephone system adapted to support first and second telephone services, comprising.
a telephone service transformer (6) comprising:
i) call break means (62) adapted to interrupt a communication between two terminals (T1, T2) using a first telephone service,
ii) calling means (63) adapted to call the two terminals (T1, T2) in parallel in order to establish respective communications with them via a second telephone service; and
iii) joining means (64) adapted to interconnect the two terminals (T1, T2) by joining the two communications between the transformer (6) and the respective terminals (T1, T2) in order to establish a communication between the terminals via the second telephone service; and
a call routing device comprising means (50) for identifying which telephone service is used for a communication between two terminals (T1, T2) at the time of establishing said communication and, for a predefined telephone service, routine means (51) for directing the call issued by one of the terminals (T1), the “calling” terminal, to the other terminal (T2), the “called” terminal, to said telephone service transformer (6).
